(19) United States
(12) Patent Application Publication
(10) Pub. No.: US 2017/0285141 A1
(43) Pub. Date: Oct. 5, 2017

(54) RADAR DEVICE FOR VEHICLES

(71) Applicant: CUBTEK INC., Hsinchu County (TW)

(72) Inventors: SHYH-JONG CHUNG, Hsinchu County (TW); HSIAO-NING WANG, Hsinchu County (TW)

(21) Appl. No.: 15/474,227

(22) Filed: Mar. 30, 2017

(30) Foreign Application Priority Data
Mar. 31, 2016 (TW) 105204530

(51) Int. Cl. G01S 7/35; G01S 13/34; G01S 13/93

(52) U.S. Cl. CPC G01S 7/354; G01S 13/931; G01S 13/34

(57) ABSTRACT

A radar device for vehicles includes a waveform generator, generating an FMCW; a transmit antenna, transmitting the FMCW; a first receive antenna, receiving a first reflected wave of the FMCW; a first mixer, receiving the FMCW and the first reflected wave to produce a first mixed signal; a second receive antenna, receiving a second reflected wave of the FMCW; a second mixer, receiving the FMCW and the second reflected wave to produce a second mixed signal; and a digital signal processor, receiving and processing the first mixed signal and the second mixed signal to produce a diversity receive signal. By use of a multipath reflection compensation, the instability issue of the signal from a remote target object is resolved.

### BACKGROUND OF THE INVENTION

### 1. Field of the Invention

The present invention relates to radar devices, and more particularly, to a radar device for vehicles.

### 2. Description of the Related Art

Common warning system for vehicles applies the radar detecting technique of frequency modulation continuous wave (FMCW) for achieving the early warning function. Regarding previously used vehicle warning device, a distance detecting radar is disposed at a predetermined position. When the vehicle moves, the distance detecting radar detects a safe distance between the vehicle and an obstruction object. When an abnormal distance is detected, the brake system of the vehicle or a crash prevention warning is triggered to lower the accident occurring possibility.

In general, a vehicle radar transmits a detecting signal by a transmitter and receives a signal feedback of the detecting signal by a receiver. By comparing the signal feedback and the originally transmitted detecting signal, the relative distance and moving speed of the vehicle against the object with the detection range are calculated. However, due to the limit of the vehicle radar typically disposed in a limited space within the vehicle body, when the vehicle radar operates, a relatively large background noise is produced, since the distance between the transmitter and the receiver is too short. Such background noise imposes negative effect upon the accuracy of the relative distance and the moving speed of the vehicle against the object calculated by the system. Also, the background noise occupies the source of the system applied for calculating the relative distance and moving speed between the vehicle and the object, thus seriously affecting the data processing rate of the system.

Therefore, the errors of the radar have to be reduced for enhancing the security of vehicle driving.

### SUMMARY OF THE INVENTION

For improving the issues above, the present invention discloses a radar device for vehicles, which resolves the instability of signal from an object at a remote distance by compensating the effect of multipath reflection of the ground.

For achieving the aforementioned objectives, an embodiment of the present invention provides a radar device for vehicles, comprising:

a waveform generator, generating a frequency modulation continuous wave (FMCW);

a transmit antenna; transmitting the frequency modulation continuous wave;

a first receive antenna, receiving a first reflected wave reflected by the frequency modulation continuous wave contacting an object;

a first mixer, receiving the frequency modulation continuous wave and the first reflected wave to produce a first mixed signal;

a second receive antenna, receiving a second reflected wave reflected by the frequency modulation continuous wave contacting the object, the first receive antenna and the second receive antenna spaced with a distance therebetween and disposed at two horizontal planes, respectively, and arranged in a longitudinal alignment against each other and vertical to the ground;

a second mixer, receiving the frequency modulation continuous wave and the second reflected wave to produce a second mixed signal; and

a digital signal processor, receiving and processing the first mixed signal and the second mixed signal to produce a diversity receive signal, so as to calculate a distance between the vehicle and the object.

With the following description of the drawings, the objectives, technical features, and effects of embodiments in accordance with the present invention are illustrated.

### BRIEF DESCRIPTION OF THE DRAWINGS

FIG. 1 is a block diagram of a radar device for vehicles in accordance with an embodiment of the present invention.

FIG. 2 is a block diagram of a radar device for vehicles in accordance with another embodiment of the present invention.

FIG. 3 is a schematic diagram illustrating the waveform simulation of the embodiment shown in FIG. 2.

### DETAILED DESCRIPTION OF THE INVENTION

The aforementioned and further advantages and features of the present invention will be understood by reference to the description of the preferred embodiment in conjunction with the accompanying drawings.

The present invention mainly provides a radar device for vehicles resolving the instability of signal from an object at a remote distance by compensating the effect of multipath reflection of the ground. The present invention is allowed to be widely operated in other embodiments. Various modifications and enhancements may be made without departing from the scope of the invention. Accordingly, the invention is not to be limited except as by the appended claims. In the description of the specification, for clearly illustrating the present invention, many specific details are provided; however, the present invention is still able to be carried out with certain details being omitted. Furthermore, commonly known steps or components may not be shown in the detail description for preventing unnecessary limitations. Identical or similar components are marked with identical or similar numeric. Please note that the components are illustrated based on a proportion for explanation but not subject to the actual component proportion and amounts. Unnecessary details are omitted to achieve the briefness of the drawings.

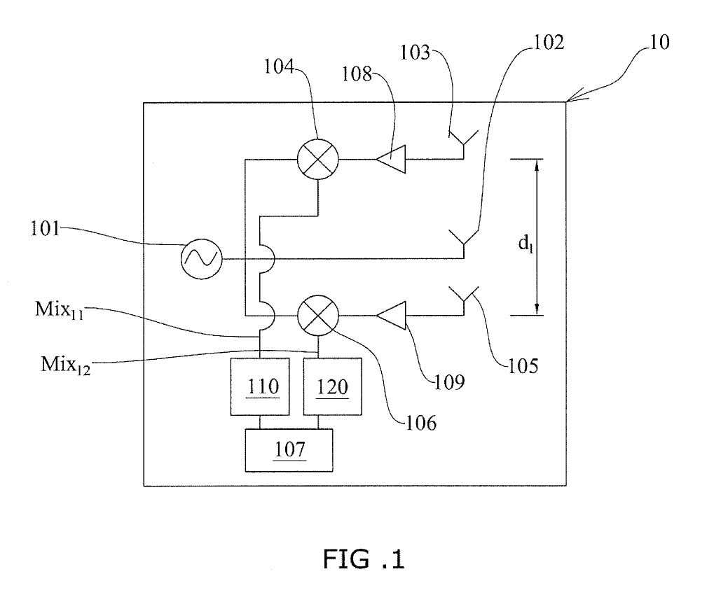

Referring to FIG. 1, an embodiment of the radar device 10 for vehicles in accordance with the present invention comprises a waveform generator 101, a transmit antenna 102, at least two receive antennas 103, 105, at least two mixers 104, 106, and a digital signal processor 107. The waveform generator 101 generates a frequency modulation continuous wave, including but not limited to a linear frequency modulation continuous wave. In an embodiment of the present invention, the frequency modulation continuous wave is allowed to be a 24 GHz frequency modulation continuous wave. The transmit antenna 102 transmits the frequency modulation continuous wave. The first receive antenna 103 receives a first reflected wave which is reflected by the frequency modulation continuous wave contacting an object; the first mixer 104 receives the frequency modulation continuous wave and the first reflected wave, and subsequently produces a first mixed signal Mix₁₁. The second receive antenna 105 receives a second reflected wave which is reflected by the frequency modulation continuous wave contacting the object; the second mixer 106 receives the frequency modulation continuous wave and the second reflected wave, and subsequently produces a second mixed signal Mix₁₂. The digital signal processor 107 receives and processes the first mixed signal Mix₁₁ and the second mixed signal Mix₁₂, and produces a diversity receive signal, so as to calculate the distance between the object and the radar device 10.

In an embodiment of the present invention, the first receive antenna 103 and the second receive antenna 105 are disposed at two horizontal planes, respectively, and arranged in a longitudinal alignment against each other and vertical to the ground, and spaced with each other with a distance d₁ included between the first receive antenna 103 and the second receive antenna 105. In an embodiment of the present invention, the length of the distance d₁ ranges from 3.5 cm to 6.5 cm. In a preferred embodiment of the present invention, the length of the distance d₁ between the first receive antenna 103 and the second receive antenna 105 is 5 cm. In other words, the second receive antenna 105 is the antenna which is closer to the ground, and the first receive antenna 103 is disposed at a height higher than the height of the second receive antenna 105 by 3.5 to 6.5 cm. Also, in the embodiment, the transmit antenna 102 is disposed between the first antenna 103 and the second antenna 105; however, the position of the transmit antenna 102 is not necessarily limited to such arrangement. In another embodiment, for facilitating the reflected wave processing, the radar device 10 further includes a first low noise amplifier 108 disposed between the first receive antenna 103 and the first mixer 104 and a second low noise amplifier 109 disposed between the second receive antenna 105 and the second mixer 106. Also, a first high frequency filter 110 is disposed between the first mixer 104 and the digital signal processor 107, and a second high frequency filter 120 is disposed between the second mixer 106 and the digital signal processor 107.

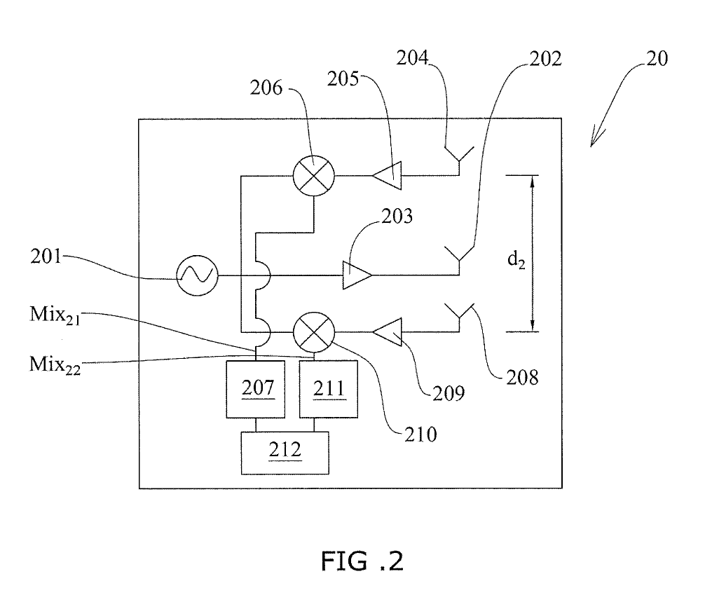

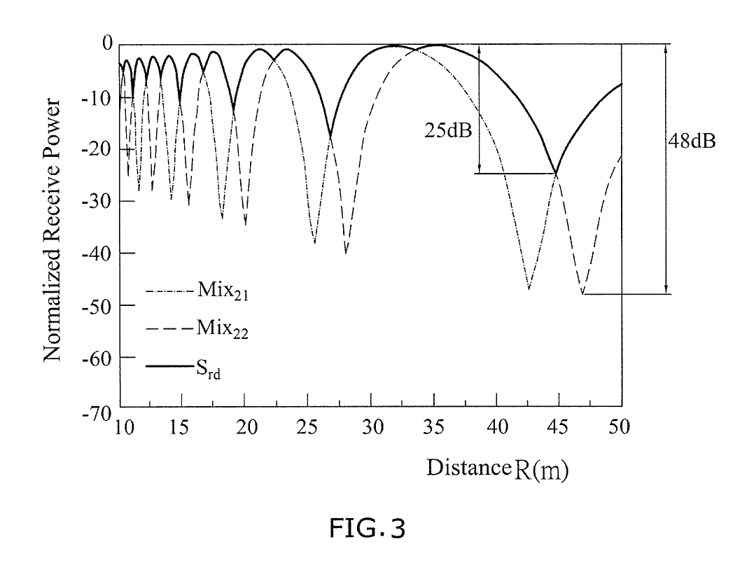

Referring to the embodiment shown by FIG. 2 and FIG. 3, a radar device 20 is installed at a simulated installation height of 50 cm; a target object is located at a height of 80 cm; and a distance d₂ between two vertically disposed antennas is 5 cm. As shown by the embodiment in FIG. 2, a waveform generator 201 of a radar device 20 is a 12 GHz voltage controlled oscillator. A 24 GHz frequency doubler 203 is disposed between a transmit antenna 202 and the waveform generator 201. A first receive antenna 204, a first low noise amplifier 205, a first mixer 206, and a first high frequency filter 207 are connected; a second receive antenna 208, a second low noise amplifier 209, a second mixer 210, and a second high frequency filter 211 are connected. In the embodiment, the first mixer 206 and the second mixer 210 are a sub-harmonic mixer. A digital signal processor 212 receives and processes a first mixed signal Mix₂₁ and a second mixed signal Mix₂₂, and subsequently produces a diversity receive signal. As shown by FIG. 3, the first mixed signal Mix₂₁ and the second mixed signal Mix₂₂ are displayed as two dotted lines, and the processed diversity receive signal S_{rd} is displayed as the a solid line. In the embodiment, variation range of the received signal power is optimized from 48 dB to 25 dB.

In the abovementioned embodiments, two receive antennas are included in the radar device for vehicles. However, it shall be understandable that the radar device including more than two, three for example, receive antennas, applying different reflected signals received by the receive antennas, and carrying out the diversity receive processing upon such signals is in the scope claimed by the present invention. In other words, two or more than two receive antennas are disposed at two horizontal planes, respectively, and arranged in a longitudinal alignment against each other and vertical to the ground, and spaced with a certain distance therebetween, such that the radar device is able to achieve a signal compensation function, so as to produce the space variety. For example, when one of the receive antenna signal feedback disappears, the other receive antenna is capable of maintaining a strong signal feedback strength. Therefore, the two receive antennas are allowed to compensate the signal weakness portion of each other, such that a target object is completely detected and tracked.

To sum up, the radar device for vehicles in accordance with embodiments of the present invention applies a multipath reflection compensation, wherein multiple receive antennas are used for receiving reflected signals, such that the reflected signals compensates each other to resolve the issue of the target signal being instable.

Although particular embodiments of the invention have been described in detail for purposes of illustration, various modifications and enhancements may be made without departing from the scope of the invention. Accordingly, the invention is not to be limited except as by the appended claims.

Through the detail explanation of the embodiments, the technical features and invention spirit of the present invention are clearly disclosed. However, the scope of the invention is not to be limited by the preferred embodiments disclosed above. On the contrary, variations and equivalent arrangements are to be included with the claimed scope of the present invention. Thus, the explanation of the claim scope shall be rendered within the widest range to cover all possible variations and equivalent arrangements.

What is claimed is:

1. A radar device for vehicles, comprising
a waveform generator, generating a frequency modulation continuous wave (FMCW);
a transmit antenna, transmitting the frequency modulation continuous wave;
a first receive antenna, receiving a first reflected wave reflected by the frequency modulation continuous wave contacting an object;
a first mixer, receiving the frequency modulation continuous wave and the first reflected wave to produce a first mixed signal;
a second receive antenna, receiving a second reflected wave reflected by the frequency modulation continuous wave contacting the object, the first receive antenna and the second receive antenna spaced with a distance therebetween and disposed at two horizontal planes, respectively, and arranged in a longitudinal alignment against each other and vertical to the ground;
a second mixer, receiving the frequency modulation continuous wave and the second reflected wave to produce a second mixed signal; and
a digital signal processor, receiving and processing the first mixed signal and the second mixed signal to produce a diversity receive signal, so as to calculate a distance between the vehicle and the object.

2. The radar device of claim 1, wherein the distance ranges from 3.5 cm to 6.5 cm.

3. The radar device of claim 1, wherein the distance is 5 cm.

4. The radar device of claim 1, further comprising a first low noise amplifier disposed between the first receive antenna and the first mixer.

5. The radar device of claim 1, further comprising a second low noise amplifier disposed between the second receive antenna and the second mixer.

6. The radar device of claim 1, further comprising a first high frequency filter disposed between the first mixer and the digital signal processor.

7. The radar device of claim 1, further comprising a second high frequency filter disposed between the first mixer and the digital signal processor.

8. The radar device of claim 1, wherein the frequency modulation continuous wave is a 24 GHz frequency modulation continuous wave.
